(19) United States
(12) Patent Application Publication
(10) Pub. No.: US 2021/0142692 A1
(43) Pub. Date: May 13, 2021

(54) METHOD AND SYSTEM FOR SKILL LEARNING

(71) Applicant: National Taiwan Normal University, Taipei City (TW)

(72) Inventors: Jon-Chao HONG, Taipei City (TW); Kai-Hsin TAI, Taipei City (TW); Jian-Hong YE, Taipei City (TW)

(73) Assignee: National Taiwan Normal University, Taipei City (TW)

(21) Appl. No.: 17/140,283

(22) Filed: Jan. 4, 2021

Related U.S. Application Data
(63) Continuation-in-part of application No. 16/594,738, filed on Oct. 7, 2019.

(30) Foreign Application Priority Data
Jun. 6, 2019 (TW) 108119662
Jun. 3, 2020 (TW) 109118633

(51) Int. Cl. G09B 19/00; G09B 5/02; G09B 19/24; G06F 3/01

(52) U.S. Cl. CPC G09B 19/003; G09B 5/02; G06F 3/0482; G06F 3/017; G06F 3/011; G09B 19/24

(57) ABSTRACT

A method for skill learning is implemented using a system including a wearable device to be worn by a user, a storage unit, and a processor communicating with the wearable device and the storage unit. The storage unit stores a plurality of virtual reality modules in the storage unit, each of the virtual reality modules containing interactive data associated with learning a skill. The method includes: accessing the storage unit to load a selected one of the virtual reality modules; and controlling the wearable device to present the interactive data contained in the selected one of the virtual reality modules to the user in the form of a virtual environment.

### CROSS-REFERENCE TO RELATED APPLICATION

This application is a continuation-in-part of U.S. patent application Ser. No. 16/594,738, which was filed on Oct. 7, 2019 and which claims priority of Taiwanese Patent Application No. 108119662 filed on Jun. 6, 2019, and this application further claims priority of Taiwanese Patent Application No. 109118633, filed on Jun. 3, 2020.

### FIELD

The disclosure relates to a method and a system for skill learning, and particularly to a method and a system that provide a virtual environment for assisting a user in skill learning.

### BACKGROUND

Conventionally, a skill (e.g., car washing, cooking, juggling, sports, dancing, etc.) may be learned from a teacher (e.g., an experienced artisan) providing lessons in a one-on-one or one-to-many manner. The teacher may first demonstrate the skill for one or more learners, and the learner(s) may attempt to perform the skill after watching the demonstration. Any error that occurs during the performance may then be corrected by the teacher.

It is noted that such a conventional way of learning may have limitations in the aspects of time and space.

### SUMMARY

Therefore, one object of the disclosure is to provide a method that provides a virtual environment for assisting skill learning by a user.

According to one embodiment of the disclosure, the method for skill learning is implemented using a system including a wearable device worn by a user, a storage unit, and a processor communicating with the wearable device and the storage unit. The storage unit stores a plurality of virtual reality modules therein, and each of the virtual reality modules contains interactive data associated with learning a skill. The method includes:

In response to a selection signal indicating a user selection from the wearable device, accessing, by the processor, the storage unit to load a selected one of the virtual reality modules; and

controlling, by the processor, the wearable device to present the interactive data contained in the selected one of the virtual reality modules to the user in the form of a virtual environment.

Another object of the disclosure is to provide a system that is configured to implement the above-mentioned method.

According to one embodiment of the disclosure, the system includes a wearable device to be worn by a user, a storage unit storing a plurality of virtual reality modules therein, and a processor communicating with the wearable device and the storage unit. Each of the virtual reality modules contains interactive data associated with learning a skill.

The processor is configured to: in response to a selection signal indicating a user selection from the wearable device, access the storage unit to load a selected one of the virtual reality modules; and control the wearable device to present the interactive data contained in the selected one of the virtual reality modules to the user in the form of a virtual environment.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a system for skill learning according to one embodiment of the disclosure;

FIG. 2 is a schematic view illustrating a selection screen presented by a display unit of the system;

FIGS. 3 to 10 are schematic views illustrating displayed screens associated with a series of steps of a practice process;

FIG. 11 is a flow chart illustrating steps of a method for skill learning according to one embodiment of the disclosure; and

FIGS. 12A to 12C form another flow chart illustrating steps of a method for skill learning according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

FIG. 1 is a block diagram illustrating a system 100 for skill learning according to one embodiment of the disclosure.

The system 100 includes a wearable device 1 to be worn by a user, a storage unit 2, and a processor 3 communicating with the wearable device 1 and the storage unit 2.

In this embodiment, the wearable device 1 includes a display unit 11, an input unit 12 and a sensor unit 15. The display unit 11 may be embodied using a headset such as a virtual reality (VR) headset to be worn on the head of the user. The input unit 12 may be embodied using a set of handheld devices that includes two devices in the form of sticks to be held by two hands of the user, or other sensing apparatuses attached to the hands and/or legs of the user.

Each of the handheld devices may include an input button pad (that includes, for example, a D-pad, an enter button, etc.) for allowing the user to input a command, and a motion detecting element (e.g., an accelerometer, a plurality of motion sensors, etc.), and the set of handheld devices may serve as a motion controller. That is to say, the input unit 12 is configured to be capable of detecting motion and gesture of the hands of the user holding the input unit 12.

The sensor unit 15 may be embodied using a plurality of sensors disposed on various parts of the body of the user, or an optical image capturing unit and/or an ultrasound sensor, and is configured to determine a body pose of the user. In this embodiment, the body pose may be one of a standing pose, a squat pose, a lied-down pose, a walking pose, a jumping pose, a tumbling pose, etc.

The storage unit 3 may be embodied using a hard disk drive, flash memory, a cloud storage server, or other forms of non-transitory storage medium.

In this embodiment, the storage unit 3 stores a software application and a plurality of virtual reality modules therein.

Specifically, each of the virtual reality modules may be in the form of a software program module containing interactive data associated with learning a particular skill.

The processor 2 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

It is noted that in some embodiments, the processor 2 and the storage unit 3 may be integrated with the wearable device 1. In other embodiments, the processor 2 and the storage unit 3 may be embodied using a computer device other than the wearable device 1 (e.g., a server, a personal computer, a laptop, a tablet, etc.) that includes a communicating component (not shown in the drawings) to communicate with the wearable device 1, which may also include a similar communicating component. The communicating component may include a short-range wireless communicating module supporting a short-range wireless communication network using a wireless technology of Bluetooth® and/or Wi-Fi, etc., and a mobile communicating module supporting telecommunication using Long-Term Evolution (LTE), the third generation (3G) and/or fourth generation (4G) of wireless mobile telecommunications technology, and/or the like.

The software application includes instructions that, when executed by the processor 2, causes the processor 2 to control the wearable device 1 to perform a number of operations related to a method for skill learning according to one embodiment of the disclosure.

FIG. 11 is a flow chart illustrating steps of the method for skill learning according to one embodiment of the disclosure. It is noted that, prior to performing the method, a number of virtual reality modules are pre-stored in the storage unit 3. Each of the virtual reality modules contains interactive data associated with learning a skill (e.g., food prepping, car washing, etc.).

In this embodiment, each of the virtual reality modules may include a practice sub-module corresponding with a practice mode, and an evaluation sub-module corresponding with an evaluation mode. The practice sub-module contains interactive data that includes a cognitive scaffolding network. The cognitive scaffolding network includes a plurality of scaffolding elements and is for providing guidance (such as a visually perceivable instruction) when the user is practicing a skill.

In step 204, when a user wears the wearable device (e.g., puts the display unit 11 on his/her head and holds the handheld device of the input unit 12 in his/her hands), the user may operate the input unit 12 to generate an initializing signal (e.g., by pressing a button on the input unit 12 or holding a specific gesture with his/her hands), and then the initializing signal is transmitted to the processor 2.

In step 206, in response to the initializing signal, the processor 2 controls the display unit 11 to display a selection screen 13 (see FIG. 2).

As shown in FIG. 2, the selection screen 13 includes a plurality of skill options 14 each corresponding with a skill, and a plurality of mode options 15 each corresponding with an operation mode. For example, the operation modes corresponding with the mode options 15 include the practice mode and the evaluation mode.

In this embodiment, each of the skill options 14 corresponds with preparing a particular kind of food on a cutting board using a kitchen knife. Several kinds of foods may be available for selection, such as leaf vegetable (e.g., Chinese cabbage), vegetables that do not require peeling (e.g., cucumber), vegetables that require peeling (e.g., carrot), round shaped vegetables (e.g., tomato, onion, cabbage, etc.), strip shaped vegetables (e.g., green bean), etc.

In step 208, the user operates the input unit 12 to select one of the skill options 14 to practice preparing one of the foods. In addition, the user operates the input unit 12 to select one of the mode options 15 to select either the practice mode or the evaluation mode.

In one example, the user may move one hand (holding the handheld device of the input unit 12) to control movement of a cursor to move to one of the skill options 14, and click the enter button on the input unit 12 to select the one of the skill options 14. Then, the user may further move his/her hand to control movement of the cursor to move to one of the mode options 15, and click the enter button to select one of the practice mode and the evaluation mode corresponding to the one of the mode options 15. Afterward, the user may operate the input unit 12 to select a start button on the selection screen 13 in a similar manner. In another example, the above operations may be done using the D-pad and the enter button of the input unit 12.

Once selection of the one of the skill options 14 and the one of the mode options 15 is made in step 208, the wearable device 1 transmits a selection signal indicating the selection to the processor 2. In response to the selection signal, in step 210, the processor 2 accesses the storage unit 3 to load a selected one of the virtual reality modules that corresponds with the selection made by the user.

In step 212, the processor 2 controls the wearable device 1 to present the interactive data contained in the selected one of the virtual reality modules to the user in the form of a virtual environment (e.g., a virtual kitchen). Specifically, the processor 2 controls the wearable device 1 to present the interactive data contained in a selected one of the practice sub-module and the evaluation sub-module based on the selection made by the user in step 208.

FIG. 3 illustrates an example of interactive data that is presented to the user through the display unit 11. In the example of FIG. 3, the interactive data corresponds with preparing Chinese cabbage using the kitchen knife in the practice mode.

Specifically, the interactive data is presented to the user in the form of a virtual environment. The user is able to see a virtual cutting board, a virtual kitchen knife, and the scaffolding elements of the cognitive scaffolding network.

In the case of FIG. 3, the scaffolding elements include an arrow 41 pointing at an object (the virtual Chinese cabbage) and a text message 51 indicating a “Step 1” of a practice process related to preparing Chinese cabbage, and instructing the user to “pick up the Chinese cabbage”. The virtual environment may also include buttons 61 for switching among various steps of the practice process of preparing Chinese cabbage (e.g., back to the previous step, repeat the current step, proceed to the next step, etc.). It is noted that the buttons 61 may be presented during each of the steps of the practice process for allowing the user to practice specific step(s) of the practice process.

Upon seeing the text message 51, the user may move his/her hand to “grab” the virtual Chinese cabbage. In response, the input unit 12 detects a hand gesture of the user, and generates a gesture signal corresponding with the hand gesture in step 214. The gesture signal is then transmitted to the processor 2.

In step 216, in response to receipt of the gesture signal from the input unit 12, the processor 2 generates an interactive gesture presentation based on the gesture signal.

Then, in step 218, the processor 2 controls the wearable device 1 to further present the interactive gesture presentation in the virtual environment.

For example, in the case of FIG. 3, when the user moves his/her hand to “grab” and “move” the virtual Chinese cabbage in the virtual environment, the interactive gesture presentation may be in the form of the virtual Chinese cabbage being moved according to the movement of the hand of the user.

After the virtual Chinese cabbage is picked up, the practice process proceeds to “Step 2”, and the text message 52 is displayed, instructing the user to put the virtual Chinese cabbage on the virtual cutting board (as shown in FIG. 4). An arrow 71 (instructing element) pointing at the virtual cutting board may be presented as a hint to the user.

After the user puts the virtual Chinese cabbage on the virtual cutting board, the practice process proceeds to “Step 3”, and the text message 53 is displayed, instructing the user to cut off a root portion of the virtual Chinese cabbage on the virtual cutting board (as shown in FIG. 5). In this case, additional scaffolding elements may be presented, such as a number cue 91 indicating an order of operation, and a dotted line 81 defining a line for the user to operate the virtual kitchen knife so as to “cut off” the root portion.

In this case, the user may be instructed to use his/her left hand to “hold” the virtual Chinese cabbage and use his/her right hand to operate the virtual kitchen knife. As such, one of the handheld devices included in the input unit 12 held by the user may serve as the virtual kitchen knife. That is, the location of the one of the handheld devices may be detected, and projected to the virtual environment as the location of the virtual kitchen knife. In some embodiments, the system 100 may include a camera (not shown in the drawings) that is configured to capture an image of the user, so as to be able to assist in detecting locations of the fingers of the user. In some embodiments, the input unit 12 may further include a glove (not shown in the drawings) that includes a motion detecting element for assisting in detecting locations of the fingers of the user.

As such, when the user is operating the virtual kitchen knife, the processor 2 may determine whether his/her fingers are in potential risk (i.e., not bent inward, and therefore may be cut by the virtual kitchen knife), and control the display unit 11 to display a safety alert notice 93 as shown in FIG. 6. In such a case, the user may be warned against executing the cut until his/her fingers are moved away.

After the user cuts off the root portion of the virtual Chinese cabbage, the practice process proceeds to “Step 4”, and the text message 54 is displayed, instructing the user to cut the virtual Chinese cabbage into six segments on the virtual cutting board (as shown in FIG. 7). Five number cues 92 indicating an order of operation, and five corresponding dotted lines 72 are displayed as additional scaffolding elements.

As the user practices, the input unit 12 may further detect an orientation of the hand holding the virtual kitchen knife (e.g., the right hand), so as to determine whether a cut to be made by the user aligns with a corresponding one of the dotted lines 72. When it is determined that the hand of the user is tilted with respect to the corresponding one of the dotted lines 72, the processor 2 may control the display unit 11 to display an accuracy alert notice 94 as shown in FIG. 8.

After the user finishes cutting the virtual Chinese cabbage, the practice process proceeds to “Step 5”, and the text message 55 is displayed, instructing the user to wash the cut virtual Chinese cabbage in a water bowl (as shown in FIGS. 9 and 10). Additional steps of the practice process (e.g., putting the cleaned virtual Chinese cabbage into a basket, moving the basket to a specific location) may be implemented.

Apart from the above practice process of the practice mode, when the evaluation mode is selected in the selection screen of FIG. 2, the interactive data presented in step 212 does not include any one of the scaffolding elements in the virtual environment. That is, the user may be instructed to perform an evaluation process similar to the practice process, but without any assistance.

In such a case, when the user moves his/her hand to perform one of the steps of an evaluation process similar to the practice process, the input unit 12 may detect a hand gesture of the user, generate a gesture signal corresponding with the hand gesture, and transmit the gesture signal to the processor 2.

In response to receipt of the gesture signal from the input unit 12 in the evaluation process, the processor 2 may be configured to generate an evaluation result based on the gesture signal (e.g., whether the left fingers are bent, the cuts are made at correctly, etc.) to determine a result of the user learning the skill. The evaluation result may be in the form of a score or a public relation (PR) measurement, and may then be stored in the storage unit 3.

In one embodiment, one of the virtual reality modules is associated with auto detailing to be performed on an exterior of an automobile. In this embodiment, the skill options 14 may include operations such as washing alloy wheels, washing a car body, wax polishing, wiping the car body, etc.

It is noted that in this embodiment, when the practice mode is selected, one or more of the scaffolding elements may be presented during the practice process. When one of the steps of the practice process involves a potential safety issue, the processor 2 may control the display unit 11 to display the safety alert notice. For example, when the user operates a high-pressure washer gun, a distance between the high-pressure washer gun, which is spraying water at a high pressure, and the alloy wheels should be greater than a predetermined safety distance. When it is determined that the distance is smaller than the safety distance, the safety alert notice may be displayed. Additionally, the processor 2 may determine a location at which the water is sprayed based on the orientation of the hands of the user, and determine whether the location registers with a preset stain on a virtual car body. When it is determined that the location is not registered with the stain, the processor 2 may control the display unit 11 to display an accuracy alert notice.

FIGS. 12A to 12C form a flow chart illustrating steps of a method for skill learning according to one embodiment of the disclosure. In the embodiment of FIGS. 12A to 12C, the storage unit 3 (see FIG. 1) stores an additional virtual reality module including the interactive data that corresponds with fire emergency training in the practice mode and in the evaluation mode.

The additional virtual reality module includes a practice sub-module corresponding with the practice mode. The practice sub-module contains interactive data that includes a cognitive scaffolding network. The cognitive scaffolding network includes a plurality of scaffolding elements (e.g., in a form of a text message) for providing the user with instructions for adjusting at least one of a hand gesture and a body pose in learning the skill.

Referring to FIG. 12A, in step S1, the processor controls the wearable device 1 to present the interactive data contained in the additional virtual reality module to the user in the form of a virtual environment. Specifically, the virtual environment presented may be a virtual building on fire. The scaffolding elements may include virtual rooms, virtual doors, virtual windows, virtual fire, a virtual fire extinguisher, etc.

In step S2, the processor 2 controls the wearable device 1 to present a message to the user, instructing the user to shout a warning of fire. In this embodiment, the system 100 may further include a microphone or other audio collecting devices (not shown) for determining whether the user has shouted loud enough. After determining that the user has shouted loud enough, the flow proceeds to one of steps S3 and step S11 based on a setting of the virtual environment. When it is determined that the user did not shout loud enough, step S2 may be repeated to instruct the user to shout again. Alternatively, the processor 2 may control the wearable device 1 to present a message to notify the user that he/she needs to shout louder.

In this embodiment, when the virtual environment is set that the user is in a burning room of the virtual building, the flow proceeds to step S3 to control, by the processor 2, the wearable device 1 to present the virtual environment as a burning room, and the user may be given a choice to practice one of two actions: attempting to extinguish the fire (step S4), or evacuating (step S10). The choices may be presented to the user, who may operate the input unit 12 to select one of the two choices.

In the case of attempting to extinguish the fire, in step S4, the processor 2 controls the wearable device 1 to present a message to the user, instructing the user to “grab” the virtual fire extinguisher. Afterward, the flow proceeds to step S5, in which the processor 2 controls the wearable device 1 to present a message to the user, instructing the user to “aim” a discharge nozzle of the virtual fire extinguisher at a source of the fire, so as to simulate the action of spraying an extinguishing agent (e.g., foams, chemicals, etc.) at the fire.

Based on an angle the user is “aiming” the discharge nozzle of the virtual fire extinguisher at the fire, the processor 2 may determine whether the action of spraying the extinguishing agent is able to extinguish the fire. In the case that the action of spraying the extinguishing agent is able to extinguish the fire (e.g., the extinguishing agent is sprayed at the bottom of the fire, as seen in step S7), the flow proceeds to step S8, in which the processor 2 controls the wearable device 1 to stop presenting the scaffolding element of virtual fire, indicating that the fire has been extinguished.

On the other hand, in the case where it is determined that the action of spraying the extinguishing agent is unable to extinguish the fire (e.g., the extinguishing agent is sprayed at the top of the fire or missed the fire, as seen in step S6), the flow proceeds to step S9, in which the processor controls the wearable device 1 to present two options for the user: attempt to extinguish the fire again (and the flow goes back to step S5), or attempt to evacuate the burning room.

In the case the user selects (using, for example, the input unit 12) to evacuate the burning room, the flow proceeds to step S10, in which the processor 2 controls the wearable device 1 to present a message to the user, instructing the user to attempt to open a closed virtual door which when opened, may allow the user to enter other parts of the virtual building. The flow then proceeds to step S12.

Further referring to FIG. 12B, when the virtual environment is set that the user is in a virtual room of the virtual building and the outside of the virtual room has caught fire, the flow proceeds to step S11 to control, by the processor 2, the wearable device 1 to present the virtual environment as a virtual room of the virtual building with the outside of the virtual room having caught fire, and to wait for a user selection of evacuating the virtual room. After the user selects (using, for example, the input unit 12) to evacuate the virtual room, the flow proceeds to step S12 as well.

In step S12, the processor 2 controls the wearable device 1 to present a message to the user, instructing the user to inspect a virtual doorknob of the virtual door. The processor 2 may assign a color to the virtual doorknob to indicate a temperature of the virtual doorknob in different scenarios.

For example, in one scenario of step S13, the virtual doorknob presented with a deep red color may indicate that the virtual doorknob has a high temperature, which means that fire is burning behind the virtual door. In such case, the processor 2 may control the wearable device 1 to present a message to the user, instructing the user not to open the virtual door, and try to find another virtual door (then the flow goes back to step S12).

In another case, in one scenario of step S14, the virtual doorknob presented with a blue or yellow color may indicate that the virtual doorknob has a normal temperature, which means that no fire is burning behind the virtual door. In such case, the processor 2 may control the wearable device 1 to present a message to the user, instructing the user to open the virtual door. Afterward, the flow proceeds to step S15.

In step S15, after the user opens the virtual door, the processor 2 may control the wearable device 1 to present one of two different scenarios to the user.

In one case, the processor 2 controls the wearable device 1 to present a scenario that smoke is present behind the virtual door. In another case, the processor 2 controls the wearable device 1 to present a scenario that no smoke is present behind the virtual door. In the scenario of smoke being present behind the virtual door, the processor 2 controls, in step S16, the wearable device 1 to present the virtual environment where smoke is present behind the virtual door, and the flow goes to step S22. On the other hand, in the scenario of no smoke behind the virtual door, the processor 2 controls, in step S17, the wearable device 1 to present the virtual environment where there is no smoke behind the virtual door, and the flow goes to step S18.

Further referring to FIG. 12C, in step S22, the processor 2 controls the wearable device 1 to present a message instructing the user to close the virtual door. After the user closes the virtual door, the processor 2 controls the wearable device 1 to present one of a first scenario of no smoke getting in the virtual room and a second scenario of smoke getting in the virtual room from a gap under the virtual door. In the first scenario, the processor 2 may control the wearable device 1 to present a message to the user, instructing the user to move around in the virtual room to look for another door (step S23). Then, the flow goes back to step S12 when the user has moved to another door.

In the second scenario, the processor 2 controls the wearable device 1 to present a message to the user, instructing the user to grab a virtual towel to block the gap under the virtual door (step S24). Afterward, the flow proceeds to step S23.

It is noted that, the processor 2 may determine whether the user has properly blocked the gap under the virtual door, and control the wearable device 1 to present a result. For example, when it is determined that the gap under the virtual door is not properly blocked, the processor 2 may control the wearable device 1 to present the smoke continuing to flow into the room through the gap under the virtual door.

In the scenario of no smoke behind the virtual door, the processor 2 controls the wearable device 1 to present the virtual environment where there is no smoke behind the virtual door (step S17), and then to present the user with the choice to move out of the virtual room to look for an exit route, or to stay in the virtual room (step S18). When the user chooses to stay in the virtual room, the flow goes to step S22. In the case the user moves out of the virtual room, the flow goes to step S19, in which the processor 1 may control the wearable device 1 to present other parts of the virtual building, such as a hallway, a staircase, etc. Additionally, the processor 2 may control the wearable device 1 to present a message to the user, instructing the user to find the nearest evacuation route (e.g., a fire escape staircase).

When the user encounters a closed virtual door (step S21) presented in the virtual environment, the user may choose to open the closed virtual door. As such, the flow then goes back to step S12.

When the user finds a virtual staircase (step S20), the processor 2 may control the wearable device 1 to present a message to the user, instructing the user to proceed down the stairs to safety while staying low to the ground.

It is noted that, in this embodiment, the processor 2 is further programmed to obtain a physical attribute of the user such as a height, a body measurement, etc. This may be done using the information obtained by the sensor unit 15 or from the user inputting the physical attribute. As the user is experiencing the virtual environment, in presenting the at least one of the scaffolding elements in the virtual environment, the processor 2 may further adjust a location at which one or more of the scaffolding elements are to be presented based on the physical attribute of the user.

For example, in the practice mode, when the user is standing in the virtual room, the messages presented to the user may be positioned at a height that is easier for the user to see without having to look up or down or to raise or lower his/her head. When the user is moving down the stairs while staying low to the ground, the messages presented to the user may be positioned relatively lower such that the user is not required to look up or raise his/her head for reading the messages.

In this embodiment, the sensor unit 15 is programmed to determine a body pose of the user and generate a body pose signal corresponding with the body pose. In the cases that the interactive data contained in the selected one of the virtual reality modules includes a message to be presented to the user, the processor 2 is programmed to control the wearable device 1 to present the message at a virtual position in the virtual environment based on the body pose signal. Furthermore, in the evaluation mode, the user is required to perform the operations as shown in FIGS. 12A to 12C without messages presented by the wearable device 1. In response to receipt of the gesture signal from the input unit and receipt of the body pose signal from the sensor unit 15 in the evaluation mode, the processor 2 is programmed to generate an evaluation result based on the gesture signal and the body pose signal, and to store the evaluation result in the storage unit 3.

According to one embodiment, the storage unit 3 stores another virtual reality module including the interactive data that corresponds with seed planting in the practice mode and in the evaluation mode. The virtual environment may be a segment of virtual agricultural land, and the scaffolding elements may include a virtual plow, virtual seeds, etc.

In this embodiment, the user may be instructed in the practice mode to perform a number of operations including plowing the virtual agricultural land to make troughs thereon in a tic-tac-toe fashion and sowing virtual seeds on the troughs on intersections of the troughs. In sowing the seeds, the processor 2 may control the wearable device 1 to present a message to the user, instructing the user to sow the virtual seeds in a specific angle (e.g., vertically downward) and in a specific depth. In the evaluation mode, the user may be required to repeat the above operations without the messages.

To sum up, embodiments of the disclosure provide a method and a system for skill learning. The system is configured to present a virtual environment to the user, and therefore the user is allowed to practice the skill by interacting with the virtual objects in the virtual environment. This eliminates the time and location constrains associated with employing a conventional teacher. Additionally, for each of the skills, a practice mode and an evaluation mode are provided, such that the skill may be practiced with the assistance of the scaffolding elements, and after practicing, the scaffolding elements may be removed and the result of the learning may be evaluated.

It is noted that in various embodiments, after a number of evaluation results associated to different users are generated and stored, an additional analysis may be performed to obtain information regarding how the users perform in the evaluation mode, such as a frequently made mistake, a specific body pose that the user frequently fail to make, how the behaviors of the users change in response to a change in the virtual environment, etc. This may be beneficial in adjusting the design of the virtual environment and the presentation of the messages in the practice mode (such as advising a better way to move in the building that is caught fire, a better route to safety, etc.), in order to enhance the effectiveness of teaching provided by the method and the system.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for skill learning, implemented using a system including a wearable device worn by a user, a storage unit, and a processor communicating with the wearable device and the storage unit, the storage unit storing a plurality of virtual reality modules therein, each of the virtual reality modules containing interactive data associated with learning a skill, the method comprising:
in response to a selection signal indicating a user selection from the wearable device, accessing, by the processor, the storage unit to load a selected one of the virtual reality modules; and
controlling, by the processor, the wearable device to present the interactive data contained in the selected one of the virtual reality modules to the user in the form of a virtual environment.

2. The method of claim 1, the wearable device including a display unit, an input unit and a sensor unit, the method further comprising, after presenting the interactive data:
detecting, by the input unit, a hand gesture of the user and generating a gesture signal corresponding with the hand gesture;
sensing, by the sensor unit, a body pose of the user and generating a body pose signal corresponding with the body pose;
in response to receipt of the gesture signal from the input unit, generating, by the processor, an interactive gesture presentation based on the gesture signal; and
controlling, by the processor, the wearable device to further present the interactive gesture presentation in the virtual environment;
wherein the interactive data contained in the selected one of the virtual reality modules includes a message to be presented to the user, and the processor is programmed to control the wearable device to present the message at a virtual position in the virtual environment based on the body pose signal.

3. The method of claim 2, further comprising, prior to accessing the storage unit to load the selected one of the virtual reality modules:
controlling, by the processor, the wearable device to present a selection screen, the selection screen including a plurality of skill options each corresponding with a skill, and a plurality of mode options each corresponding with an operation mode; and
in response to receipt of a selection signal indicating one of the skill options and one of the mode options, transmitting, by the input unit, the selection signal to the processor;
wherein the processor loads a selected one of the virtual reality modules based on the selection signal.

4. The method of claim 3, wherein:
one of the mode options corresponds with a practice mode;
the selected one of the virtual reality modules includes a practice sub-module corresponding with the practice mode, the practice sub-module containing interactive data that includes a cognitive scaffolding network, the cognitive scaffolding network including a plurality of scaffolding elements for providing the user with instructions for adjusting at least one of a hand gesture and a body pose in learning the skill; and
when the practice mode is selected, the step of presenting the interactive data includes presenting at least one of the scaffolding elements in the virtual environment;
wherein the scaffolding elements includes one or more of an arrow, a broken line, a number cue indicating an order of operation, and a visual cue.

5. The method of claim 4, wherein:
the processor is further programmed to obtain a physical attribute of the user; and
the presenting of the at least one of the scaffolding elements in the virtual environment includes adjusting a location at which the at least one of the scaffolding elements is to be presented based on the physical attribute of the user.

6. The method of claim 3, wherein:
one of the mode options corresponds with an evaluation mode;
the selected one of the virtual reality modules includes an evaluation sub-module corresponding with the evaluation mode; and
when the evaluation mode is selected, the step of presenting the interactive data includes not presenting the scaffolding elements in the virtual environment.

7. The method of claim 6, further comprising, after presenting the interactive data:
in response to receipt of the gesture signal from the input unit and receipt of the body pose signal from the sensor unit in the evaluation mode, generating, by the processor, an evaluation result based on the gesture signal and the body pose signal; and
storing the evaluation result in the storage unit.

8. The method of claim 1, wherein one of the virtual reality modules is associated with preparing food on a cutting board using a kitchen knife.

9. The method of claim 1, wherein one of the virtual reality modules is associated with auto detailing to be performed on an exterior of an automobile.

10. The method of claim 1, wherein one of the virtual reality modules is associated with emergency evacuation from a building.

11. A system for skill learning, comprising:
a wearable device to be worn by a user;
a storage unit storing a plurality of virtual reality modules therein, each of the virtual reality modules containing interactive data associated with learning a skill; and
a processor communicating with said wearable device and said storage unit, wherein said processor is configured to:
in response to a selection signal indicating a user selection from said wearable device, access said storage unit to load a selected one of the virtual reality modules; and
control said wearable device to present the interactive data contained in the selected one of the virtual reality modules to the user in the form of a virtual environment.

12. The system of claim 11, wherein:
said wearable device includes a display unit an input unit, and a sensor unit;
after presenting the interactive data, said input unit is configured to detect a hand gesture of the user and generate a gesture signal corresponding with the hand gesture, and said sensor unit is configured to sense a body pose of the user and generate a body pose signal corresponding with the body pose;
in response to receipt of the gesture signal from said input unit, said processor generates an interactive gesture presentation based on the gesture signal; and
said processor further controls said wearable device to further present the interactive gesture presentation in the virtual environment;
wherein the interactive data contained in the selected one of the virtual reality modules includes a message to be presented to the user, and said processor is programmed to control said wearable device to present the message at a virtual position in the virtual environment based on the body pose signal.

13. The system of claim 12, wherein, prior to accessing said storage unit to load the selected one of the virtual reality modules:
said processor controls said wearable device to present a selection screen, the selection screen including a plurality of skill options each corresponding with a skill, and a plurality of mode options each corresponding with an operation mode; and
in response to receipt of a selection signal indicating one of the skill options and one of the mode options, said input unit transmits the selection signal to the processor;
wherein said processor loads a selected one of the virtual reality modules based on the selection signal.

14. The system of claim 13, wherein:
one of the mode options corresponds with a practice mode;
the selected one of the virtual reality modules includes a practice sub-module corresponding with the practice mode, the practice sub-module containing interactive data that includes a cognitive scaffolding network, the cognitive scaffolding network including a plurality of scaffolding elements for providing the user with instructions for adjusting at least one of a hand gesture and a body pose in learning the skill; and
when the practice mode is selected, said processor further controls said wearable device to present at least one of the scaffolding elements in the virtual environment;
wherein the scaffolding elements presented by said wearable device includes one or more of an arrow, a broken line, a number cue indicating an order of operation, and a visual cue.

15. The system of claim 14, wherein said processor is further programmed to obtain a physical attribute of the user, and is programmed to present the at least one of the scaffolding elements in the virtual environment by adjusting a location at which the at least one of the scaffolding elements is to be presented based on the physical attribute of the user.

16. The system of claim 13, wherein:
one of the mode options corresponds with an evaluation mode;
the selected one of the virtual reality modules includes an evaluation sub-module corresponding with the evaluation mode; and
when the evaluation mode is selected, said processor further controls said wearable device to not present the scaffolding elements in the virtual environment.

17. The system of claim 16, wherein, after presenting the interactive data, in response to receipt of the gesture signal from said input unit in the evaluation mode, said processor generates an evaluation result based on the gesture signal, and stores the evaluation result in said storage unit.

18. The system of claim 11, wherein one of the virtual reality modules is associated with preparing food on a cutting board using a kitchen knife.

19. The system of claim 11, wherein one of the virtual reality modules is associated with auto detailing to be performed on an exterior of an automobile.

20. The system of claim 11, wherein one of the virtual reality modules is associated with emergency evacuation from a building.
